(19) United States
(12) Patent Application Publication
(10) Pub. No.: US 2026/0252910 A1
(43) Pub. Date: Aug. 27, 2026

(54) DATA PREDICTION

(71) Applicant: Arm Limited, Cambridge (GB)

(72) Inventors: Alexander Cole SHULYAK, Austin, TX (US); Michael David ACHENBACH, Austin, TX (US); Aditi BANSAL, Gaithersburg, MD (US); William James MCAVOY, Raleigh, NC (US); Bipin Prasad Heremagalur RAMAPRASAD, Austin, TX (US); Nicholas Todd HUMPHRIES, Austin, TX (US)

(21) Appl. No.: 19/065,061

(22) Filed: Feb. 27, 2025

(51) Int. Cl. G06N 5/022

(52) U.S. Cl. CPC G06N 5/022

(57) ABSTRACT

A data processing apparatus is provided. A processing pipeline transfers one or more control signals corresponding to an instruction through a plurality of stages, at least one of the stages is configured to write data to storage circuitry. A data prediction pipeline receives an indication of a load instruction that loads data from memory to a register in the register file, based on the indication performs a determination of whether the load instruction is eligible for predicted data, and based on the determination provides the predicted data as a prediction of the data. Switching circuitry responds to at least part of the processing pipeline being unused to cause the at least one of the stages to write the predicted data to the storage circuitry.

### TECHNICAL FIELD

The present disclosure relates to data processing.

### DESCRIPTION

It is desirable to reduce a latency between load instructions and dependent instructions that use data that would be fetched by those load instructions. Data value prediction is one technique that aims to predict the data that will be loaded, but it remains desirable to reduce the latency between the two instructions, preferably so there is a reduced delay between the predicted data arriving and the dependent instruction being executable.

### SUMMARY

Viewed from a first example configuration, there is provided a data processing apparatus comprising: a processing pipeline configured to transfer one or more control signals corresponding to an instruction through a plurality of stages, wherein at least one of the stages is configured to write data to storage circuitry; a data prediction pipeline configured to receive an indication of a load instruction configured to load data from memory to a register in the register file, based on the indication to perform a determination of whether the load instruction is eligible for predicted data, and based on the determination to provide the predicted data as a prediction of the data; and switching circuitry configured to respond to at least part of the processing pipeline being unused to cause the at least one of the stages to write the predicted data to the storage circuitry.

Viewed from a second example configuration, there is provided a data processing method comprising: transferring one or more control signals corresponding to an instruction through a plurality of stages, wherein at least one of the stages is configured to write data; receiving an indication of a load instruction configured to load data from memory to a register in the register file; based on the indication, performing a determination of whether the load instruction is eligible for predicted data; based on the determination, providing the predicted data as a prediction of the data; and responding to at least part of the processing pipeline being unused to cause the at least one of the stages to write the predicted data.

Viewed from a third example configuration, there is provided a non-transitory computer-readable medium storing computer-readable code for fabrication of the data processing apparatus.

Viewed from a fourth example configuration, there is provided a system comprising: the data processing apparatus, implemented in at least one packaged chip; at least one system component; and a board, wherein the at least one packaged chip and the at least one system component are assembled on the board.

Viewed from a fifth example configuration, a chip-containing product comprising the system, wherein the system is assembled on a further board with at least one other product component.

### BRIEF DESCRIPTION OF THE DRAWINGS

The present invention will be described further, by way of example only, with reference to embodiments thereof as illustrated in the accompanying drawings, in which:

FIG. 1 illustrates a system in accordance with some examples;

FIG. 2 shows an example in which a number of the processing pipelines are available, and in which a number of the data prediction pipelines are available;

FIG. 3 schematically shows a downgrading mechanism that enables the data value prediction to be made speculatively, and therefore efficiently;

FIG. 4 illustrates an example of a bypass being used to bypass one of the processing stages of a pipeline;

FIG. 5 illustrates a combined diagram that shows the various stages of data value prediction pipeline and the data processing pipelines;

FIG. 6 illustrates a method of data processing in accordance with some embodiments in the form of a flow chart; and

FIG. 7 shows one or more packaged chips, with the apparatus implemented on one chip or distributed over two or more of the chips.

### DESCRIPTION OF EXAMPLE EMBODIMENTS

Before discussing the embodiments with reference to the accompanying figures, the following description of embodiments is provided.

There is provided a data processing apparatus comprising: a processing pipeline configured to transfer one or more control signals corresponding to an instruction through a plurality of stages, wherein at least one of the stages is configured to write data to storage circuitry; a data prediction pipeline configured to receive an indication of a load instruction configured to load data from memory to a register in the register file, based on the indication to perform a determination of whether the load instruction is eligible for predicted data, and based on the determination to provide the predicted data as a prediction of the data; and switching circuitry configured to respond to at least part of the processing pipeline being unused to cause the at least one of the stages to write the predicted data to the storage circuitry.

In the above examples, a data prediction pipeline is provided, which is able to respond to a load instruction by performing a prediction on the data that will be returned by that load instruction. Since load instructions can be particularly slow, such a prediction can be useful for speeding up the overall efficiency of the data processing apparatus. The switching circuitry is able to make use of another processing pipeline (the processing pipeline) to write the predicted data into storage circuitry. In particular, when the processing pipeline is unused, the data from the prediction pipeline can be written to storage circuitry (e.g. instead of data that might be generated along the processing pipeline). The storage circuitry can take a number of forms as will be discussed below but in some embodiments it is fast for instructions to retrieve operands and execute from the storage circuitry as opposed to an external memory such as a main DRAM memory. The storage circuitry may be local to the CPU.

In some examples, the data processing apparatus comprises: a shared port to write the predicted data, which is usable by the data prediction pipeline when it is unused by the processing pipeline. The processing pipeline and the data prediction pipeline can therefore share one or more ports. Under normal circumstances, the processing pipeline uses the port, but when it is unused the port can instead be used by the data prediction pipeline. This reduces the overall number of ports that are required to access the storage circuitry, which in turn reduces the circuit size and power that are required.

In some examples, the data processing apparatus comprises: a plurality of processing pipelines including the processing pipeline; a plurality of shared ports to write the predicted data, including the shared port, each associated with an associated processing pipeline in the processing pipelines, and each usable by the data prediction pipeline when it is unused by that associated processing pipeline, wherein the switching circuitry is configured to respond to at least part of one of the plurality of processing pipelines being unused to cause the one of the stages to write the predicted data to the storage circuitry. There need not be one single data processing pipeline. Instead in some examples, there is a plurality of the data processing pipelines available, each with their own shared port. When one of the data processing pipelines is available (e.g. unused), the switching circuit makes it possible for the data processing pipeline to be used by the data prediction pipeline.

In some examples, the storage circuitry comprises a general register file comprising a register. There are a number of forms that the storage circuitry can take. But in these examples, the storage circuitry includes or is a general register file. The general register file may contain one or more registers, which are extremely fast forms of storage within a CPU that instructions can interact with in order to write or read data. Consequently, the data predictions can be written to the register for use by another instruction.

In some examples, the storage circuitry comprises a cache. The storage circuitry may therefore be or include a cache. Such a cache may be used as a cache to the general register file, for instance, so that data can be accessed more quickly (i.e. without having to wait for any delay that might be experienced in writing to a general register file).

In some examples, the data processing apparatus comprises: broadcast circuitry configured to broadcast a notification to indicate where the predicted data can be obtained from by a dependent instruction configured to use the data. The dependent instruction could take the form of an instruction that uses data obtained by a load instruction. For example, the dependent instruction might perform a logical or arithmetic operation (e.g. ADD) on data that is obtained as a result of a load instruction. The broadcast circuitry is provided to notify other instructions, via a broadcast signal, that the data has been provided (e.g. via data prediction). The broadcast signal might also indicate precisely where the data has been provided to (e.g. the register). For instance, the broadcast signal might include a ptag (physical tag), which references the instruction that provides the data so that other dependent instructions can execute (provided their other dependencies are resolved).

In some examples, the data processing apparatus comprises: selection circuitry configured to select the load instruction as a predicted instruction for which the predicted data will be generated; and first downgrade circuitry configured to downgrade the predicted instruction to a non-predicted instruction in dependence on a condition being met in respect of the predicted instruction. The load instruction is treated as a predicted instruction for which predicted data will be generated before it is necessarily known that the predicted data can be used. Consequently, first downgrade circuitry is provided, which is able to downgrade the prediction circuitry back to a non-predicted load instruction when a particular condition is met-the condition relating to the predicted instruction.

In some examples, the condition is dependent on a decoding of the load instruction. The condition may depend on the decoding, which is to say that the decision to treat the load instruction as a predicted (load) instruction is taken before the decoding of the load instruction is complete. The condition may therefore take into account the type of the instruction and whether a prediction is likely to be possible. For instance, if the instruction turns out to not be a load instruction then a prediction is clearly not practical. Similarly, certain types of load instruction might not be applicable to predictions, in which case they can be downgraded back to a non-prediction instruction.

In some examples, the condition relates to an availability of the at least part of the processing pipeline; and the predicted data is speculatively provided before the condition is resolved. Another condition that might be considered is the extent to which the at least part of the processing pipeline is available. For example if the at least part of the processing pipeline (will be) unavailable then the downgrade to a non-predicted instruction may take place. In this sense, the predicted data is provided before it is known whether the downgrade will occur. In this sense, the predicted data is speculatively provided.

In some examples, the data processing apparatus comprises: pipeline hole detection circuitry configured to determine that the at least one of the stages will be unused at a future cycle so that the predicted data can be written to the storage circuitry. The pipeline hole detection circuitry is able to determine that the at least one of the stages will have a ‘hole’ in it at a future cycle—e.g. will not be processing data, so that the predicted data can instead be written to the storage circuitry as opposed to data that would be passing through the processing pipeline if there was no hole. The future cycle is therefore a cycle where the switching circuitry will insert the predicted data.

In some examples, the pipeline hole detection circuitry is configured to determine that the at least one of the stages will be unused at the future cycle by determining that a previous part of the pipeline that is previous to the at least one of the stages is currently unused. One way in which the pipeline hole detection circuitry can determine a future hole is by considering a previous part of the pipeline that is previous to the at least one of the stages. In particular, if the previous part of the pipeline is currently empty then the at least one of the stages will be empty in a number of processor cycles time.

In some examples, the data processing apparatus comprises: selection circuitry configured to select the load instruction as a predicted instruction for which the predicted data will be generated; and second downgrade circuitry configured to downgrade the predicted instruction to a non-predicted instruction in dependence on a determination of the pipeline hole detection circuitry. The pipeline hole detection circuitry can therefore be used to determine whether there will be a ‘hole’ at a point in the pipeline where the predicted data for the predicted instruction can be provided. If no such hole exists then the predicted data will not be able to be handled and so the predicted instruction is downgraded into a non-predicted instruction.

In some examples, the data processing apparatus comprises: a plurality of processing pipelines including the processing pipeline; and a plurality of data prediction pipelines including the data prediction pipeline, wherein the pipeline hole detection circuitry is configured to determine how many of the processing pipelines will be unused at the future cycle. In these examples, a number of data processing pipelines exist, any one of which can be used to insert the prediction of the data into. The pipeline hole detection circuitry is therefore configured to determine how many of those processing pipelines will have ‘holes’ and if the number of holes is greater than or equal to the number of predictions of data that exist (keeping in mind that multiple predictions may be made for different load instructions) then no downgrade is necessary. Otherwise, one or more downgrades are required in order to reduce the number of predictions to be less than or equal to the number of holes so that the predictions can be provided appropriately.

In some examples, assignment circuitry configured to assign one of the processing pipelines that is unused to one of the data prediction pipelines. The assignment circuitry is thereby able to allocate unused processing pipelines to one of the data prediction pipelines so that data from that data prediction pipeline can be passed to the allocated unused processing pipeline.

In some examples, the plurality of stages is configured to transfer the instruction in lockstep from a point at which the instruction is decoded until the instruction is issued; and the data prediction pipeline is configured to operate in lockstep with the plurality of stages. In general, instructions pass through the plurality of stages from a point of decoding (e.g. the decode stage) to the issuing of the instruction for execution (e.g. the issuing stage) at a rate of one cycle per stage. This rate is the same for both of the data prediction pipeline and the processing pipeline so that the predicted data can be ‘seamlessly’ inserted from the data prediction pipeline into the processing pipeline.

In some examples, the data processing apparatus comprises: a consuming processing pipeline configured to transfer one or more control signals corresponding to a dependent instruction through a plurality of consuming processing pipeline stages; and the dependent instruction is configured to consume the data. The dependent instruction can be thought of as an instruction that uses the data provided by the load instruction. It passes through a consuming processing pipeline, which might be the same as the processing pipeline although could be a different pipeline altogether.

In some examples, the data processing apparatus comprises: bypass circuitry to respond to a bypass indication made in respect of the dependent instruction, to enable the dependent instruction to bypass one or more of the plurality of stages so that the dependent instruction is issued without a stall. It is possible for a bypass indication provided so that some of the pipeline can by bypassed. For example, a bypass might be possible for queueing structures if those queues are empty. This might occur from the predict pipe to the fetch queue for instance, or from the fetch stage to the decode stage (i.e. bypassing a decode queue). This might also occur with issue queues for instance if the issue queue is empty and the sources are ready. The exact process by which this occurs is not material—there are a number of example techniques in the literature in which such a bypass is possible. Nevertheless, with this bypass in place, it is possible for the dependent instruction to be issued without a stall, despite the fact that it depends on data that is provided by the load instruction. Under normal circumstances (without data prediction) a stall of several cycles would be necessary in order for the data to be loaded (e.g. from memory or a cache). With data prediction, a stall might still ordinarily be required since the prediction of the data cannot arrive prior to the load instruction being executed. Yet this would ordinarily involve the prediction of the data being made available for a later processing cycle. In the present technique, the prediction of the data is made available in the same processor cycle.

In some examples, the determination of whether the load instruction is eligible for the predicted data occurs when the load instruction is fetched. When the load instruction is fetched (e.g. at a fetch stage), it is possible to determine that the load instruction is eligible for the predicted data. This can be achieved by the use of a predictor that has previously determined that the load instruction (or at least a fetched block of instructions containing the load instruction) has a predictable value associated with it. Similarly, the load instruction and the dependent instruction that uses the data obtained from the load instruction may be decoded and/or renamed at the same time as the load instruction.

Particular embodiments will now be described with reference to the figures.

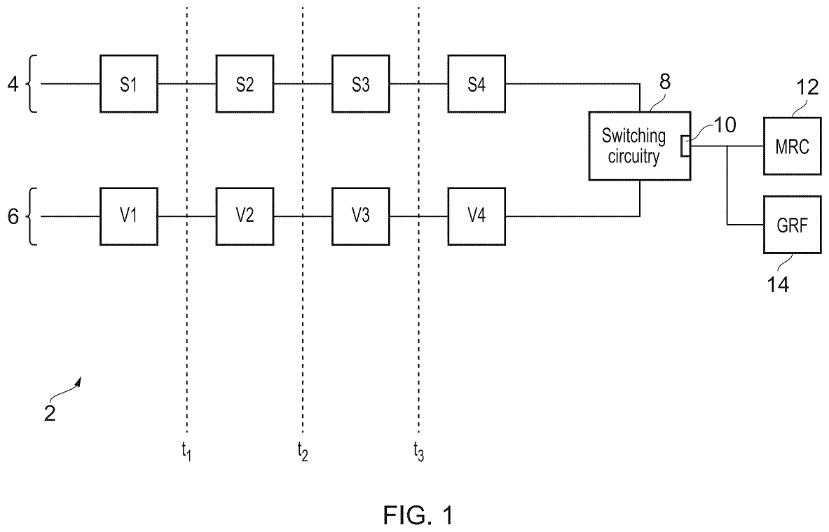

FIG. 1 illustrates a system 2 in accordance with some examples. The system includes a processing pipeline 4, which transfers control signals between a number of stages (S1-S4). The actual nature of these stages is not material, but in a traditional abstracted pipeline, these could correspond to fetch (S1), decode (S2), execute (S3), and writeback (S4) stages. Typically, a control signal that corresponds with an instruction passes through each of these stages at a rate of one stage per processor cycle. At least one of the stages (S4) is able to write to storage circuitry via one or more ports 10. Here, the storage circuitry takes the form of a General Purpose Register File (GRF) 14 and a Main Result Cache (MRC) 12. The GRF 14 stores one or more registers, which are used to both store data generated by instructions and to store data that is provided to instructions. Typically, writing to the GRF can take more than one processor cycle to complete, and consequently, the MRC 12 is provided so that the data can be accessed more quickly.

A data prediction pipeline 6 is also provided. The data prediction pipeline 6 contains a number of stages (V1-V4) through which controls signals pass in order to provide a prediction of data. Data prediction is a technique in which the data that is obtained from a load instruction is predicted so that the load instruction need not be executed in order for the data to be obtained. This can be achieved by using a small, fast cache close to the processor to store data that was previously obtained by load instructions. In value prediction, the predicted value is provided much more quickly that the load instruction is able to obtain the data from memory. The load instruction effectively becomes a ‘confirmation load’ which confirms that the data obtained from the data value prediction is in fact correct. If the value prediction turns out to be incorrect, then a flush of the pipeline occurs, essentially ‘rewinding’ execution.

Here, switching circuitry 8 is provided, which is able to switch between data provided by the main processing pipeline 4 and the data prediction pipeline 6. The output of the switching circuitry 8 is provided, via a port 10, to the MRC 12 and/or GRF 14. In this way, it is possible for the data prediction pipeline to effectively ‘commandeer’ the port 10 that would ordinarily be available to the data processing pipeline 4 if that port 10 would otherwise go unused (e.g. if there is a hole in the data processing pipeline 4). This makes it possible for data predictions to be made available without the need to provide additional ports.

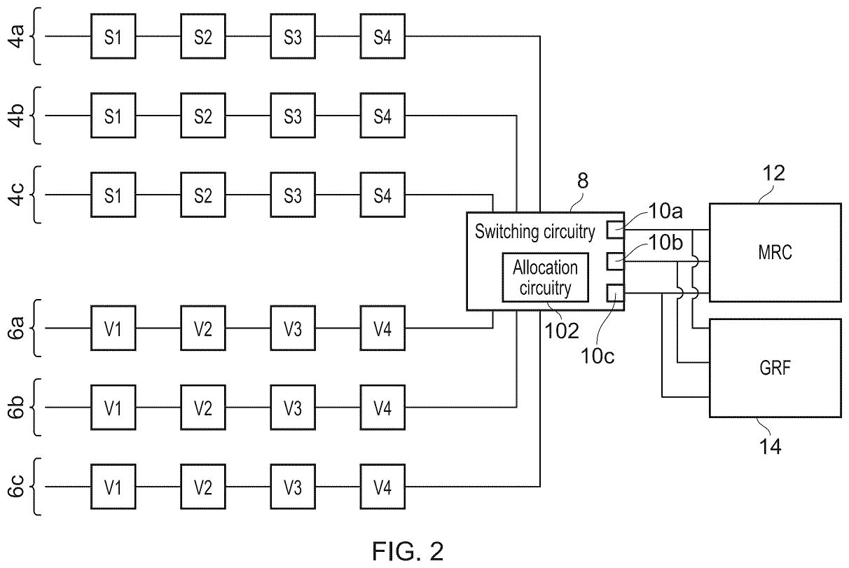

FIG. 2 shows an example in which a number of the processing pipelines 4a, 4b, 4c are available, and in which a number of the data prediction pipelines 6a, 6b, 6c are available. Here, each of the data prediction pipelines may provide predicted data for a different load instruction and each of the data processing pipelines 4a, 4b, 4c may have its port 10a, 10b, 10c ‘commandeered’, provided it is otherwise unused, in order to provide data from the data prediction pipeline 10a, 10b, 10c. Allocation circuitry 102 is provided to allocate the processing pipelines 4a, 4b, 4c to the data prediction pipelines 6a, 6b, 6c depending on availability. So for instance, if only one of the processing pipelines 4c has a hole, and only one of the data prediction pipelines 6a has a data prediction, then the allocation circuitry 102 will associate the processing pipeline 4c to the data prediction pipeline 6a.

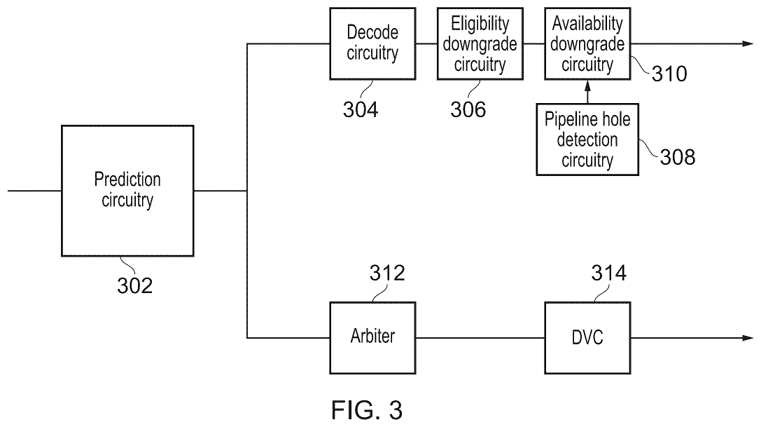

FIG. 3 schematically shows a downgrading mechanism that enables the data value prediction to be made speculatively, and therefore efficiently. Prediction circuitry 302 can operate at a time when instructions (e.g. blocks of instructions) are fetched from memory. At this time, the prediction circuitry can predict when the instructions contain any instructions for which a data value prediction can be made. Having produced this prediction, an arbiter 312 is provided to determine which of the instructions should have predictions made. This can be done based on which banks of the DVC the predictions need to access and the bank/port availability for that cycle. The data values can then be acquired from a Data Value Cache (DVC) 314. Note that throughout these stages 302, 312, 314, no decoding of the instructions has been performed, which means that these decisions are made without knowledge of what the instructions are (even that they are load instructions for instance). Instead, decoding can occur along a parallel track in decoding circuitry 304. From there, with knowledge of what the instructions are, eligibility downgrade circuitry 306 exists, which offers the opportunity for the instructions to be downgraded based on that decoding. For instance, if a particular instruction is determined to not be a load instruction, then it may be ineligible for data value prediction, regardless of what the arbiter 312 might decide. Such an instruction can therefore be downgraded to a (non-predicted) instruction.

Pipeline hole detection circuitry 308 exists to detect holes in pipelines so that a pipeline can be commandeered. The pipeline hole detection circuitry may, for instance, conclude that a hole that currently exists in a pipeline that operates in lockstep will equate to a hole in a later point in the pipeline. If that later point is targeted to be the location of the switching circuitry, then spotting a hole in a pipeline now should equate with an opportunity for a prediction of a data value to be inserted in some number of processing cycles. The availability of future holes is provided by the pipeline hole detection circuitry 308 to availability downgrade circuitry 310, which offers a second opportunity for an instruction to be downgraded to a non-predicted instruction. That is if there are four load instructions in a block but only three anticipated future holes, then one of the instructions can be demoted from a predicted instruction to a non-predicted instruction so that the capacity of holes is not exceeded.

In this manner, the predictions of the data values are obtained speculatively before it is known whether the prediction will actually be used.

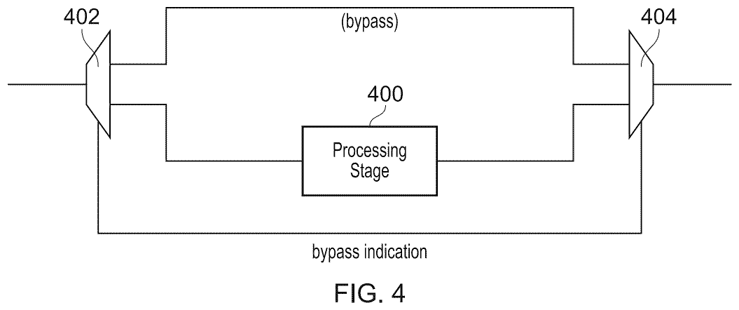

FIG. 4 illustrates an example of a bypass being used to bypass one of the processing stages of a pipeline. Here, a bypass indication is used to determine whether a processing stage 400 should be avoided or not. The incoming signal is passed to a demultiplexer 402, which selects either the processing stage 400 or a bypass path using a bypass indication signal. The same bypass indication signal can then be used to control a multiplexer 404 that selects from either the processing stage 400 or the bypass path in order to provide an output.

The exact circumstances and technique used for the bypass are immaterial. By providing such a bypass at a point of issue, it is possible for a dependent instruction (one that uses the data provided by the load instruction) to bypass some processing stages. In particular, the issue circuitry can be bypassed with the knowledge that the dependent instruction's source data will be provided by the value prediction pipeline, so it can be accelerated. This makes it possible for the data of a load instruction to be provided at a same processor cycle that an instruction that is dependent on that load instruction is executed. That is, a prediction of the load that the load instruction will provide is obtained and passed to a dependent instruction to consume in a same processor cycle. Meanwhile, the load instruction is converted to a confirmation load instruction in order to confirm that the load instruction executed correctly.

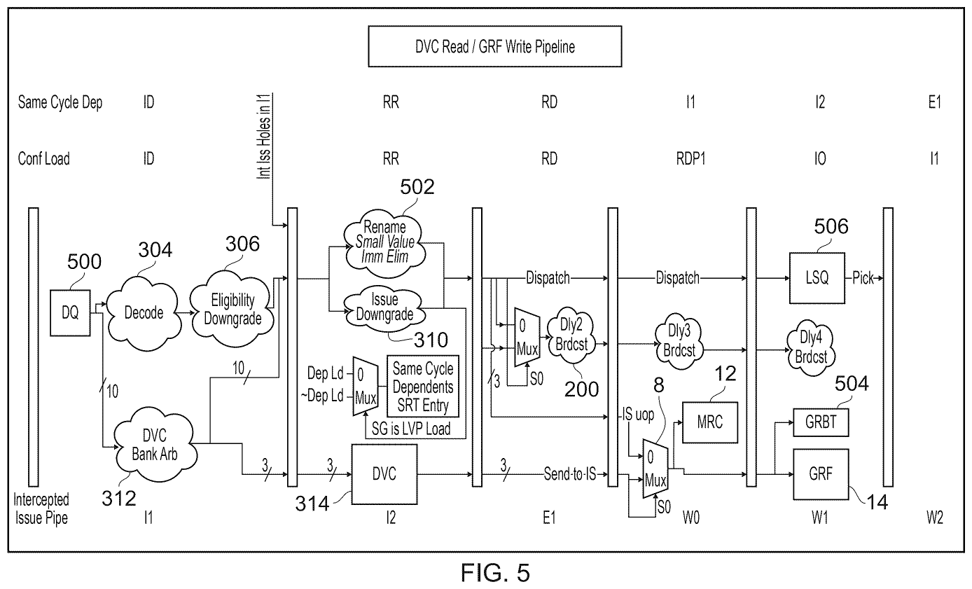

FIG. 5 illustrates a combined diagram that shows the various stages of data value prediction pipeline and the data processing pipelines.

Instructions are pulled out of a decode queue 500 and provided to decode circuitry 304 as well as an arbiter 312 as previously described. In addition, after decoding by the decode circuitry 304, some of the instructions may be marked as being suitable for downgrade by the eligibility downgrade circuitry 306 depending on the decoding. Both the confirmatory load and the same cycle dependency instruction (an instruction that is, for instance, fetched and/or decoded in the same cycle as the load instruction and that relies on the data loaded by the load instruction) are in an ‘ID’ stage (decode).

During a second stage, the Data Value Cache (DVC) 314 is accessed to obtain a prediction of the data. During this stage, register renaming occurs and downgrading may occur based on the availability of data processing pipelines. Both the confirmation load and the same cycle dependency instruction are in an ‘RR’ stage (rename). At the same time, register renaming 502 may take place for the load instruction. Register renaming can be used to eliminate small immediate values. Instead of actually performing any calculation that uses a small immediate value, this can instead be performed at a time that the data value affected by the small immediate value is consumed.

During a third stage, the confirmation load and the same cycle dependency instruction are dispatched. This is also the point at which the broadcast circuitry 200 may broadcast a signal. The broadcast occurs to indicate to dependent instructions that, if they were to begin the issue process now, by the time they reach their execute stages, the source data will be available.

In a next (fourth) stage, the same cycle dependency instruction is issued while the confirmation load is staged for issue. This is the point at which the predicted data can also be inserted using the selection circuitry 8 (which in this example takes the form of a multiplexer). Using a port that is conventionally associated with the intercepted/commandeered pipeline, the data is written to the MRC 12 during a first writeback stage (W1) of the commandeered pipeline.

Finally, in a fifth stage, the data is written to the GRF 14 and the General Purpose Register File Ready Bit Table (GRBT) 504 is updated to indicate that the data is now available—specifically it indicates readiness to future dispatched instructions after delay broadcasts stop. Also during this stage, the load (which is now treated as a confirmation load) is dispatched to a load store queue (LSQ) and so from the context of the load, this stage acts as a first issue stage (I0). Meanwhile, the same cycle dependent instruction can be issued in the fifth stage and executed (not shown) in the sixth stage. As previously discussed, if the bypass of FIG. 4 is implemented, then the first execution stage (E1) of the same cycle dependency instruction can execute in the fifth stage as the data is written to the GRF.

In this example, the fourth and fifth stages also contain delayed broadcast circuitry. These circuits are used to broadcast readiness to instructions that were not in the issue circuitry at the time of the original broadcast. These are used to fill the gap between original broadcast and the update of the Ready-Bit-Table which indicates readiness to all instructions yet to be dispatched to the issue circuitry. These delayed broadcasts broadcast to instructions about to be dispatched to the issue circuitry rather than to the entire issue circuitry. Each instruction broadcasts, and then continues to broadcast every cycle following until the ready-bit-table is updated. Much like the processing pipelines, the broadcast circuitry 200 that is initially used could be commandeered from another processing pipeline 4.

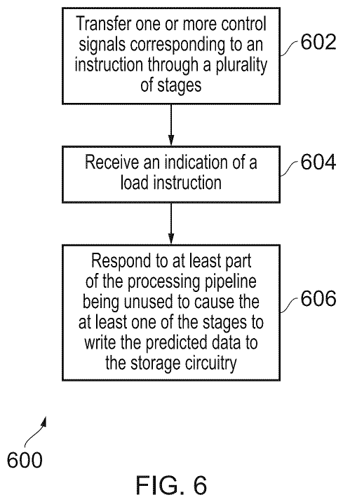

FIG. 6 illustrates a method of data processing in accordance with some embodiments in the form of a flow chart 600. At a step 602, one or more control signals corresponding to an instruction are transferred through a plurality of stages. At step 604, an indication of a load instruction is received. At a step 606, when at least part of the processing pipeline is unused, the at least one of the stages is used to write the predicted data to the storage circuitry.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

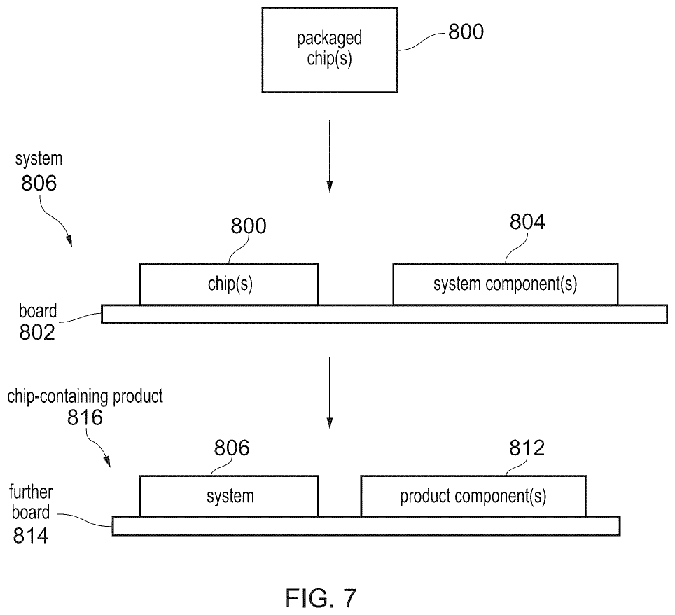

As shown in FIG. 7, one or more packaged chips 700, with the apparatus described above implemented on one chip or distributed over two or more of the chips, are manufactured by a semiconductor chip manufacturer. In some examples, the chip product 700 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 700 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 700 are assembled on a board 702 together with at least one system component 704 to provide a system 706. For example, the board may comprise a printed circuit board. The board substrate may be made of any of a variety of materials, e.g. plastic, glass, ceramic, or a flexible substrate material such as paper, plastic or textile material. The at least one system component 704 comprise one or more external components which are not part of the one or more packaged chip(s) 700. For example, the at least one system component 704 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 716 is manufactured comprising the system 706 (including the board 702, the one or more chips 700 and the at least one system component 704) and one or more product components 712. The product components 712 comprise one or more further components which are not part of the system 706. As a non-exhaustive list of examples, the one or more product components 712 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 706 and one or more product components 712 may be assembled on to a further board 714.

The board 702 or the further board 714 may be provided on or within a device housing or other structural support (e.g. a frame or blade) to provide a product which can be handled by a user and/or is intended for operational use by a person or company.

The system 706 or the chip-containing product 716 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

The present technique could be configured as follows:
1. A data processing apparatus comprising:
a processing pipeline configured to transfer one or more control signals corresponding to an instruction through a plurality of stages, wherein at least one of the stages is configured to write data to storage circuitry;
a data prediction pipeline configured to receive an indication of a load instruction configured to load data from memory to a register in the register file, based on the indication to perform a determination of whether the load instruction is eligible for predicted data, and based on the determination to provide the predicted data as a prediction of the data; and
switching circuitry configured to respond to at least part of the processing pipeline being unused to cause the at least one of the stages to write the predicted data to the storage circuitry.
2. The data processing apparatus according to clause 1, comprising:
a shared port to write the predicted data, which is usable by the data prediction pipeline when it is unused by the processing pipeline.
3. The data processing apparatus according to clause 2, comprising:
a plurality of processing pipelines including the processing pipeline;
a plurality of shared ports to write the predicted data, including the shared port, each associated with an associated processing pipeline in the processing pipelines, and each usable by the data prediction pipeline when it is unused by that associated processing pipeline, wherein
the switching circuitry is configured to respond to at least part of one of the plurality of processing pipelines being unused to cause the one of the stages to write the predicted data to the storage circuitry.
4. The data processing apparatus according to any preceding clause, wherein
the storage circuitry comprises a general register file comprising a register.
5. The data processing apparatus according to any preceding clause, comprising:
broadcast circuitry configured to broadcast a notification to indicate where the predicted data can be obtained from by a dependent instruction configured to use the data.
6. The data processing apparatus according to any preceding clause, comprising:
selection circuitry configured to select the load instruction as a predicted instruction for which the predicted data will be generated; and
first downgrade circuitry configured to downgrade the predicted instruction to a non-predicted instruction in dependence on a condition being met in respect of the predicted instruction.
7. The data processing apparatus according to clause 6, wherein
the condition is dependent on a decoding of the load instruction.
8. The data processing apparatus according to clause 6, wherein
the condition relates to an availability of the at least part of the processing pipeline; and
the predicted data is speculatively provided before the condition is resolved.
9. The data processing apparatus according to any preceding clause, comprising:
pipeline hole detection circuitry configured to determine that the at least one of the stages will be unused at a future cycle so that the predicted data can be written to the storage circuitry.
10. The data processing apparatus according to clause 9, wherein
the pipeline hole detection circuitry is configured to determine that the at least one of the stages will be unused at the future cycle by determining that a previous part of the pipeline that is previous to the at least one of the stages is currently unused.
11. The data processing apparatus according to any one of clauses 9-10, comprising:
selection circuitry configured to select the load instruction as a predicted instruction for which the predicted data will be generated; and
second downgrade circuitry configured to downgrade the predicted instruction to a non-predicted instruction in dependence on a determination of the pipeline hole detection circuitry.
12. The data processing apparatus according to clause 11, comprising:
a plurality of processing pipelines including the processing pipeline; and
a plurality of data prediction pipelines including the data prediction pipeline, wherein
the pipeline hole detection circuitry is configured to determine how many of the processing pipelines will be unused at the future cycle.
13. The data processing apparatus according to clause 12, comprising:
assignment circuitry configured to assign one of the processing pipelines that is unused to one of the data prediction pipelines.
14. The data processing apparatus according to any preceding clause, wherein
the plurality of stages is configured to transfer the instruction in lockstep from a point at which the instruction is decoded until the instruction is issued; and
the data prediction pipeline is configured to operate in lockstep with the plurality of stages.
15. The data processing apparatus according to any preceding clause, comprising:
a consuming processing pipeline configured to transfer one or more control signals corresponding to a dependent instruction through a plurality of consuming processing pipeline stages; and
the dependent instruction is configured to consume the data.
16. The data processing apparatus according to clause 15, comprising:
bypass circuitry to respond to a bypass indication made in respect of the dependent instruction, to enable the dependent instruction to bypass one or more of the plurality of stages so that the dependent instruction is issued without a stall.
17. A data processing method comprising:
transferring one or more control signals corresponding to an instruction through a plurality of stages, wherein at least one of the stages is configured to write data;
receiving an indication of a load instruction configured to load data from memory to a register in the register file;
based on the indication, performing a determination of whether the load instruction is eligible for predicted data;
based on the determination, providing the predicted data as a prediction of the data; and
responding to at least part of the processing pipeline being unused to cause the at least one of the stages to write the predicted data.
18. A non-transitory computer-readable medium storing computer-readable code for fabrication of the data processing apparatus of clause 1.
19. A system comprising:
the data processing apparatus of any one of clauses 1-16, implemented in at least one packaged chip;
at least one system component; and
a board, wherein
the at least one packaged chip and the at least one system component are assembled on the board.
20. A chip-containing product comprising the system of clause 19, wherein
the system is assembled on a further board with at least one other product component.

We claim:

1. A data processing apparatus comprising:
a processing pipeline configured to transfer one or more control signals corresponding to an instruction through a plurality of stages, wherein at least one of the stages is configured to write data to storage circuitry;
a data prediction pipeline configured to receive an indication of a load instruction configured to load data from memory to a register in the register file, based on the indication to perform a determination of whether the load instruction is eligible for predicted data, and based on the determination to provide the predicted data as a prediction of the data; and
switching circuitry configured to respond to at least part of the processing pipeline being unused to cause the at least one of the stages to write the predicted data to the storage circuitry.

2. The data processing apparatus according to claim 1, comprising:
a shared port to write the predicted data, which is usable by the data prediction pipeline when it is unused by the processing pipeline.

3. The data processing apparatus according to claim 2, comprising:
a plurality of processing pipelines including the processing pipeline;
a plurality of shared ports to write the predicted data, including the shared port, each associated with an associated processing pipeline in the processing pipelines, and each usable by the data prediction pipeline when it is unused by that associated processing pipeline, wherein
the switching circuitry is configured to respond to at least part of one of the plurality of processing pipelines being unused to cause the one of the stages to write the predicted data to the storage circuitry.

4. The data processing apparatus according to claim 1, wherein
the storage circuitry comprises a general register file comprising a register.

5. The data processing apparatus according to claim 1, comprising:
broadcast circuitry configured to broadcast a notification to indicate where the predicted data can be obtained from by a dependent instruction configured to use the data.

6. The data processing apparatus according to claim 1, comprising:
selection circuitry configured to select the load instruction as a predicted instruction for which the predicted data will be generated; and
first downgrade circuitry configured to downgrade the predicted instruction to a non-predicted instruction in dependence on a condition being met in respect of the predicted instruction.

7. The data processing apparatus according to claim 6, wherein
the condition is dependent on a decoding of the load instruction.

8. The data processing apparatus according to claim 6, wherein
the condition relates to an availability of the at least part of the processing pipeline; and
the predicted data is speculatively provided before the condition is resolved.

9. The data processing apparatus according to claim 1, comprising:
pipeline hole detection circuitry configured to determine that the at least one of the stages will be unused at a future cycle so that the predicted data can be written to the storage circuitry.

10. The data processing apparatus according to claim 9, wherein
the pipeline hole detection circuitry is configured to determine that the at least one of the stages will be unused at the future cycle by determining that a previous part of the pipeline that is previous to the at least one of the stages is currently unused.

11. The data processing apparatus according to claim 9, comprising:
selection circuitry configured to select the load instruction as a predicted instruction for which the predicted data will be generated; and
second downgrade circuitry configured to downgrade the predicted instruction to a non-predicted instruction in dependence on a determination of the pipeline hole detection circuitry.

12. The data processing apparatus according to claim 11, comprising:
a plurality of processing pipelines including the processing pipeline; and
a plurality of data prediction pipelines including the data prediction pipeline, wherein
the pipeline hole detection circuitry is configured to determine how many of the processing pipelines will be unused at the future cycle.

13. The data processing apparatus according to claim 12, comprising:
assignment circuitry configured to assign one of the processing pipelines that is unused to one of the data prediction pipelines.

14. The data processing apparatus according to claim 1, wherein
the plurality of stages is configured to transfer the instruction in lockstep from a point at which the instruction is decoded until the instruction is issued; and
the data prediction pipeline is configured to operate in lockstep with the plurality of stages.

15. The data processing apparatus according to claim 1, comprising:
a consuming processing pipeline configured to transfer one or more control signals corresponding to a dependent instruction through a plurality of consuming processing pipeline stages; and
the dependent instruction is configured to consume the data.

16. The data processing apparatus according to claim 15, comprising:
bypass circuitry to respond to a bypass indication made in respect of the dependent instruction, to enable the dependent instruction to bypass one or more of the plurality of stages so that the dependent instruction is issued without a stall.

17. A data processing method comprising:
transferring one or more control signals corresponding to an instruction through a plurality of stages, wherein at least one of the stages is configured to write data;
receiving an indication of a load instruction configured to load data from memory to a register in the register file;
based on the indication, performing a determination of whether the load instruction is eligible for predicted data;
based on the determination, providing the predicted data as a prediction of the data; and
responding to at least part of the processing pipeline being unused to cause the at least one of the stages to write the predicted data.

18. A non-transitory computer-readable medium storing computer-readable code for fabrication of the data processing apparatus of claim 1.

19. A system comprising:
the data processing apparatus of claim 1, implemented in at least one packaged chip;
at least one system component; and
a board, wherein
the at least one packaged chip and the at least one system component are assembled on the board.

20. A chip-containing product comprising the system of claim 19, wherein
the system is assembled on a further board with at least one other product component.
